(19) United States
(12) Patent Application Publication
(10) Pub. No.: US 2025/0371443 A1
(43) Pub. Date: Dec. 4, 2025

(54) APPARATUS AND METHODS FOR TRAVEL RESERVATION MODIFICATION USING A SPLIT-SCREEN GRAPHICAL USER INTERFACE

(71) Applicant: TELEPERFORMANCE SE, Paris (FR)

(72) Inventors: Juan Leonardo Pereyra Collazo, Paris (FR); Gustavo Santana, Paris (FR); Santiago Martinez, Paris (FR); Omar Ladino, Paris (FR)

(21) Appl. No.: 19/305,095

(22) Filed: Aug. 20, 2025

Related U.S. Application Data
(62) Division of application No. 17/164,544, filed on Feb. 1, 2021.

(51) Int. Cl. G06Q 10/02; G06F 3/0482; G06F 3/04842; G06F 3/04886; G06Q 20/38; G06Q 30/0283

(52) U.S. Cl. CPC G06Q 10/027; G06F 3/0482; G06F 3/04842; G06F 3/04886; G06Q 20/381; G06Q 30/0283

(57) ABSTRACT

Embodiments described herein provide apparatus and methods for efficiently modifying existing travel reservations stored in a GDS using a graphical user interface for issuing commands to the GDS. These include commands that would typically require manual entry of commands and arguments using a command-line interface. The graphical user interface can be displayed on a display device of a computer system and used by an agent to modify the reservation by selecting a different flight, to change seating arrangements, to meet basic needs, such as wheelchair assistance and food accommodations, and to help reduce any costs charged to the user as a result of the changes as the modifications can be entered more quickly and with fewer errors.

### CROSS-REFERENCE TO RELATED APPLICATIONS

This application is a divisional of and claims priority to co-pending U.S. patent application Ser. No. 17/164,544, filed Feb. 1, 2021, having attorney docket number TELP-0008-01.01US, the entire content of which is incorporated herein by reference.

### FIELD

Embodiments of the present invention generally relate to the field of electronic scheduling and reservation systems. More specifically, embodiments of the present invention relate to apparatus and methods for facilitating the modification of existing travel arrangements.

### BACKGROUND

Today, airline travel arrangements are often created using an online platform. Many electronic travel websites have become popular, each offering users the ability to identify fares, travel dates and times, seating arrangements, etc., using their personal computers or smart devices in an online capacity. The user is able to interact with the website to confirm the arrangement with the online platform and pay the associated fare and fees.

However, it is presently difficult, costly, or impossible for users to modify or cancel existing travel arrangements using these same websites. Instead, the user typically calls the airline or a travel agent to make changes to their prior arrangements, which often takes 20 minutes or longer. In some cases, these changes may be voluntary on the part of the user, such as when the user wishes to change travel dates or to upgrade or downgrade their seating class (e.g., first class, business class, economy class, etc.). In other cases, the changes to the prior travel arrangements may be involuntary due to departure delay or cancelation of a flight due to weather, for example.

Existing approaches to modifying existing travel arrangements are largely inefficient because they require airline employees and travel agents (“agents”) to use a legacy command-line interface that is inefficient and requires extensive training to comprehend the various command, syntax, and functions required to make simple modifications. The commands issued by the command-line interface are used to communicate with a global distribution system (GDS) and other relevant knowledge bases for making modifications to existing travel arrangements. This approach leads to additional costs to the user when flight arrangement are modified due to the inefficient, error-prone, time-consuming nature of the process using existing command-line interfaces.

Moreover, when using the traditional approach to modify an existing travel arrangement, an agent must confirm the availability of the desired date of travel, review the criteria associated with the arrangement (e.g., seating class, meal service, basic assistance, etc.), and apply all airlines rules associated with the change, such as fees, refunds, etc. This process is made significantly more complicated when a reservation is made that includes multiple passengers. The complicated nature of this approach often leads to mistakes on the part of the agent when modifying travel arrangements. In these cases, an agent may be penalized and required to pay an agency debit memo (ADM) in recompense. Furthermore, the agent may have to access third-party tools to perform basic functions such as currency conversion when creating/modifying reservations in different countries.

What is needed is a mechanism for making modifications to existing travel arrangements that does not require command-line user input techniques.

### SUMMARY

Accordingly, an embodiment of the present invention includes an approach to modifying online travel reservations using an intuitive and efficient graphical user interface, without requiring the use of a complicated and unintuitive command-line interface. Such an approach reduces costs to consumers and advantageously increases the efficiency of modifying (or canceling) travel arrangements.

Embodiments of the present invention provide apparatus and methods for efficiently modifying existing travel reservations stored in a GDS using a graphical user interface for issuing commands to the GDS. These include commands that would typically require manual entry of commands and arguments using a command-line interface with complex and technical syntax. The graphical user interface of the present invention embodiments can be displayed on a display device of a computer system and used by an agent to modify the reservation by selecting a different flight, to change seating arrangements, to meet basic needs, such as wheelchair assistance and food accommodations, and to help reduce any costs charged to the user as a result of the changes as the modifications can be entered more quickly and with fewer errors.

According to one embodiment, a method of modifying a flight reservation stored on a global distribution system (GDS) is disclosed. The method includes receiving a flight reservation number associated with an existing flight reservation at a field of a graphical user interface, inputting the flight reservation number to a GDS that stores the existing flight reservation, accessing flight information stored on the GDS associated with the flight reservation number, receiving reservation modification information at the graphical user interface, and releasing the reservation modification information to the GDS to modify the existing flight reservation according to the reservation modification information.

According to some embodiments, the method includes receiving a flight reservation number type at a second field of the graphical user interface, and accessing flight information stored on the GDS associated with the flight reservation number based on the reservation number type.

According to some embodiments, the method includes receiving GDS identification information at a second field of the graphical user interface indicating the GDS that stores the existing flight reservation, and accessing flight information stored on the GDS associated with the flight reservation number based on the GDS identification information.

According to some embodiments, the method includes displaying costs associated with modify the existing flight reservation according to the reservation modification information on the graphical user interface.

According to some embodiments, the method includes automatically converting a currency associated with the costs to a different currency and displaying the costs on the graphical user interface using the different currency.

According to some embodiments, the method includes displaying a confirmation screen on the graphical user interface before releasing the reservation modification information to the GDS.

According to some embodiments, the confirmation screen includes information of the existing flight reservation displayed on the graphical user interface, the reservation modification information displayed on the graphical user interface, and an interactive confirmation button displayed on the graphical user interface for confirming the reservation modification information before releasing the reservation modification information to the GDS to modify the existing flight reservation according to the reservation modification information.

According to a different embodiment, a method of canceling a flight reservation stored on a global distribution system (GDS) is disclosed. The method includes receiving a flight reservation number associated with an existing flight reservation at a field of a graphical user interface, inputting the flight reservation number to a GDS that stores the existing flight reservation, accessing flight information stored on the GDS associated with the flight reservation number, receiving a cancelation request at the graphical user interface to cancel the existing flight reservation, displaying costs associated with the cancelation request, and releasing the cancelation request to the GDS to cancel the existing flight reservation.

According to some embodiments, the method includes receiving a flight reservation number type at a second field of the graphical user interface, and accessing flight information stored on the GDS associated with the flight reservation number based on the reservation number type.

According to some embodiments, the method includes receiving GDS identification information at a second field of the graphical user interface indicating the GDS that stores the existing flight reservation, and accessing flight information stored on the GDS associated with the flight reservation number based on the GDS identification information.

According to some embodiments, the method includes automatically converting a currency associated with the costs to a different currency, and displaying the costs on the graphical user interface using the different currency.

According to some embodiments, the method includes displaying a confirmation screen on the graphical user interface before releasing the cancelation request to the GDS.

According to some embodiments, the confirmation screen includes an interactive confirmation button displayed on the graphical user interface for confirming the reservation modification information before releasing the reservation modification information to the GDS to cancel the existing flight reservation.

According to another embodiment, an apparatus for modifying a flight reservation stored on a global distribution system is disclosed. The apparatus includes a memory for storing data, a display device operable to display an on-screen graphical user interface, an input device for interacting with the on-screen graphical user interface, a network interface for communicating with the GDS, and a processor operable to receive a flight reservation number associated with an existing flight reservation at a field of the on-screen graphical user interface from the input device, transmit the flight reservation number to the GDS storing the existing flight reservation over the network interface, access flight information stored on the GDS associated with the flight reservation number over the network interface, receive reservation modification information at the on-screen graphical user interface from the input device, and release the reservation modification information to the GDS using the network interface to modify the existing flight reservation according to the reservation modification information.

According to some embodiments, the processor is further operable to receive a flight reservation number type at a second field of the on-screen graphical user interface from the input device, and access flight information stored on the GDS associated with the flight reservation number based on the reservation number type.

According to some embodiments, the processor is further operable to receive GDS identification information at a second field of the on-screen graphical user interface indicating the GDS that stores the existing flight reservation from the input device, and access flight information stored on the GDS associated with the flight reservation number based on the GDS identification information over the network interface.

According to some embodiments, the processor is further operable to display costs associated with modify the existing flight reservation according to the reservation modification information on the on-screen graphical user interface, automatically convert a currency associated with the costs to a different currency, and display the costs on the on-screen graphical user interface using the different currency.

According to some embodiments, the processor is further operable to display a confirmation screen on the on-screen graphical user interface before releasing the reservation modification information to the GDS.

According to some embodiments, the confirmation screen includes a comparison of the existing flight reservation to the reservation modification information displayed on the graphical user interface, and an interactive confirmation button displayed on the graphical user interface for confirming the reservation modification information before releasing the reservation modification information to the GDS to modify the existing flight reservation according to the reservation modification information.

According to some embodiments, the network interface is configured to communicate with the GDS over the Internet.

### BRIEF DESCRIPTION OF THE DRAWINGS

The accompanying drawings, which are incorporated in and form a part of this specification, illustrate embodiments of the invention and, together with the description, serve to explain the principles of the invention:

FIG. 1 depicts an exemplary on-screen graphical user interface for identifying and accessing information pertaining to an existing airline reservation according to embodiments of the present invention.

FIG. 2 depicts an exemplary on-screen graphical user interface for reviewing passenger and itinerary information associated with an existing airline reservation according to embodiments of the present invention.

FIG. 3 depicts an exemplary on-screen graphical user interface for modifying itinerary information of an existing airline reservation for a selected user according to embodiments of the present invention.

FIG. 4 depicts an exemplary on-screen graphical user interface including information of both the original trip and the new itinerary for comparing details of the respective flights during a reservation modification process according to embodiments of the present invention.

FIG. 5 depicts an exemplary on-screen graphical user interface for displaying a confirmation indicating that the original itinerary has been modified successfully according to embodiments of the present invention.

FIG. 6 depicts an exemplary on-screen graphical user interface for canceling an existing airline reservation according to embodiments of the present invention.

FIG. 7 depicts an exemplary on-screen graphical user interface for canceling an existing airline reservation according to embodiments of the present invention.

FIG. 8 depicts an exemplary on-screen graphical user interface for displaying confirmation information for a flight cancelation according to embodiments of the present invention.

FIG. 9 depicts a confirmation dialogue displayed on an on-screen graphical user interface that includes relevant flight information and an accept button for finalizing the cancellation of the displayed flights and releasing the flight cancelation to the associated GDS according to embodiments of the present invention.

FIG. 10 is a flow chart depicting an exemplary computer-implemented process for modifying an existing airline reservation hosted on a GDS using an interactive graphical user interface according to embodiments of the present invention.

FIG. 11 is a flow chart depicting an exemplary computer-implemented process for canceling an existing airline reservation hosted on a GDS using an interactive graphical user interface.

FIG. 12 is a block diagram depicting an exemplary computer system platform upon which embodiments of the present invention may be implemented

### DETAILED DESCRIPTION

Reference will now be made in detail to several embodiments. While the subject matter will be described in conjunction with the alternative embodiments, it will be understood that they are not intended to limit the claimed subject matter to these embodiments. On the contrary, the claimed subject matter is intended to cover alternative, modifications, and equivalents, which may be included within the spirit and scope of the claimed subject matter as defined by the appended claims.

Furthermore, in the following detailed description, numerous specific details are set forth in order to provide a thorough understanding of the claimed subject matter. However, it will be recognized by one skilled in the art that embodiments may be practiced without these specific details or with equivalents thereof. In other instances, well-known methods, procedures, components, and circuits have not been described in detail as not to unnecessarily obscure aspects and features of the subject matter.

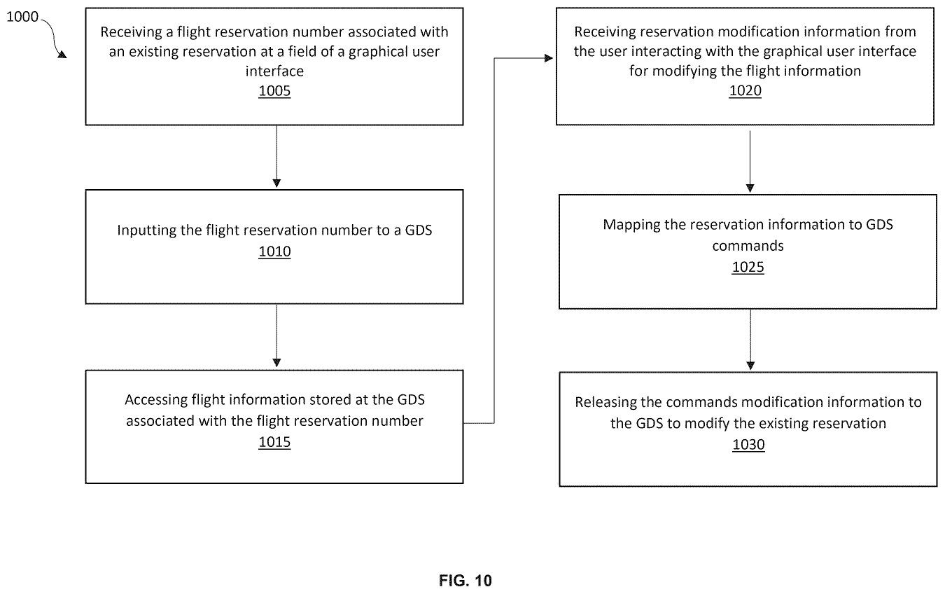

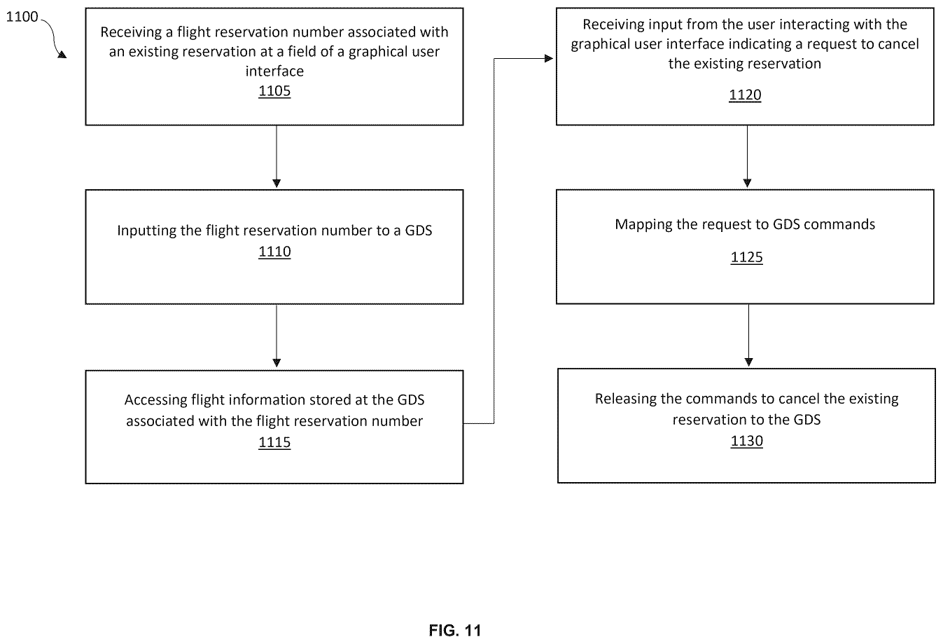

Portions of the detailed description that follow are presented and discussed in terms of a method. Although steps and sequencing thereof are disclosed in a figure herein (e.g., FIGS. 10-11) describing the operations of this method, such steps and sequencing are exemplary. Embodiments are well suited to performing various other steps or variations of the steps recited in the flowchart of the figure herein, and in a sequence other than that depicted and described herein.

Some portions of the detailed description are presented in terms of procedures, steps, logic blocks, processing, and other symbolic representations of operations on data bits that can be performed on computer memory. These descriptions and representations are the means used by those skilled in the data processing arts to most effectively convey the substance of their work to others skilled in the art. A procedure, computer-executed step, logic block, process, etc., is here, and generally, conceived to be a self-consistent sequence of steps or instructions leading to a desired result. The steps are those requiring physical manipulations of physical quantities. Usually, though not necessarily, these quantities take the form of electrical or magnetic announces capable of being stored, transferred, combined, compared, and otherwise manipulated in a computer system. It has proven convenient at times, principally for reasons of common usage, to refer to these announces as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout, discussions utilizing terms such as “accessing,” “configuring,” “setting,” “storing,” “transmitting,” “retransmitting,” “authenticating,” “identifying,” “requesting,” “reporting,” “determining,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Some embodiments may be described in the general context of computer-executable instructions, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

### User Interface for Airline Reservation Modification

Embodiments of the present invention provide apparatus and methods for efficiently modifying existing travel reservations stored in a GDS using a graphical user interface for issuing commands to the GDS. These include commands that would typically require manual entry of commands and arguments using a command-line interface with complex syntax. In one example, airline travel reservations are described. The graphical user interface can be displayed on a display device of a computer system and used by an agent to modify the reservation by selecting a different flight, to change seating arrangements, to meet basic needs, such as wheelchair assistance and food accommodations, and to help reduce any costs charged to the user as a result of the changes as the modifications can be entered more quickly and with fewer errors.

According to embodiments, airline reservation information is accessed from a GDS. The GDS stores and updates information related to airline travel, and often includes information related to hotels, rental cars, cruises, etc. Relevant information can be accessed by agents in real-time for modifying airline reservations, such as booked travel dates and times, prices, including fees, taxes, etc., and airline rules, among other information. The specific rules applied to modifications of existing travel arrangements for an airline can advantageously be updated on-the-fly without requiring modification of any underlying code.

In the following discussion, interactive elements (e.g., buttons, menus, and fields) of the respective graphical user interfaces are configured to automatically send instructions and commands to a GDS for modifying existing airline reservations and can use existing APIs to automatically present and collect any associated fares, fees, and taxes. Furthermore, the graphical user-interface can be configured to display costs and fees in a desired currency, and the costs and fees are automatically converted to the desired currency and displayed to the user.

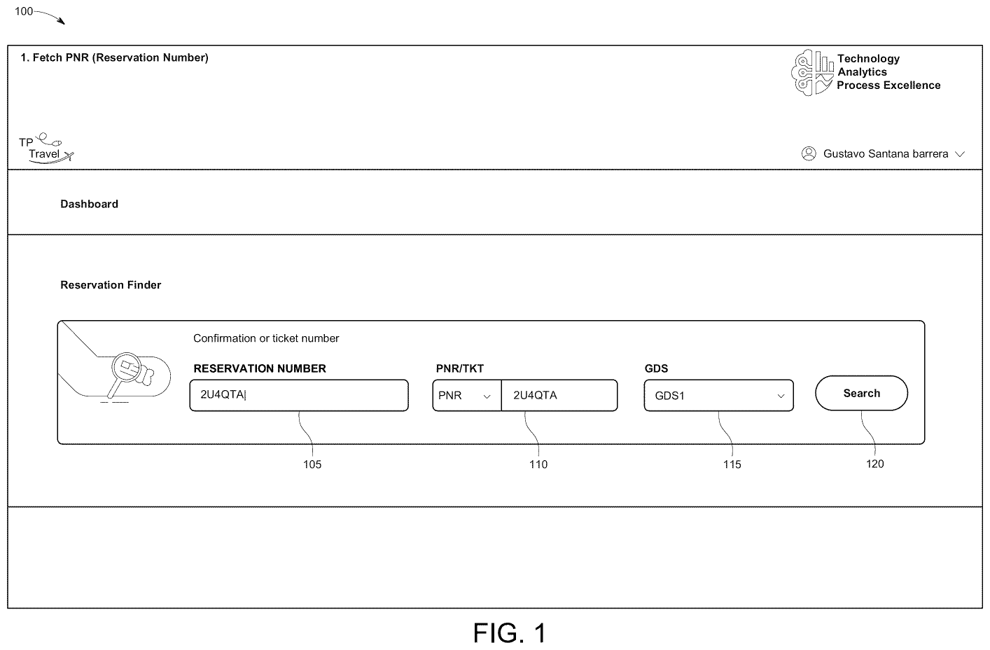

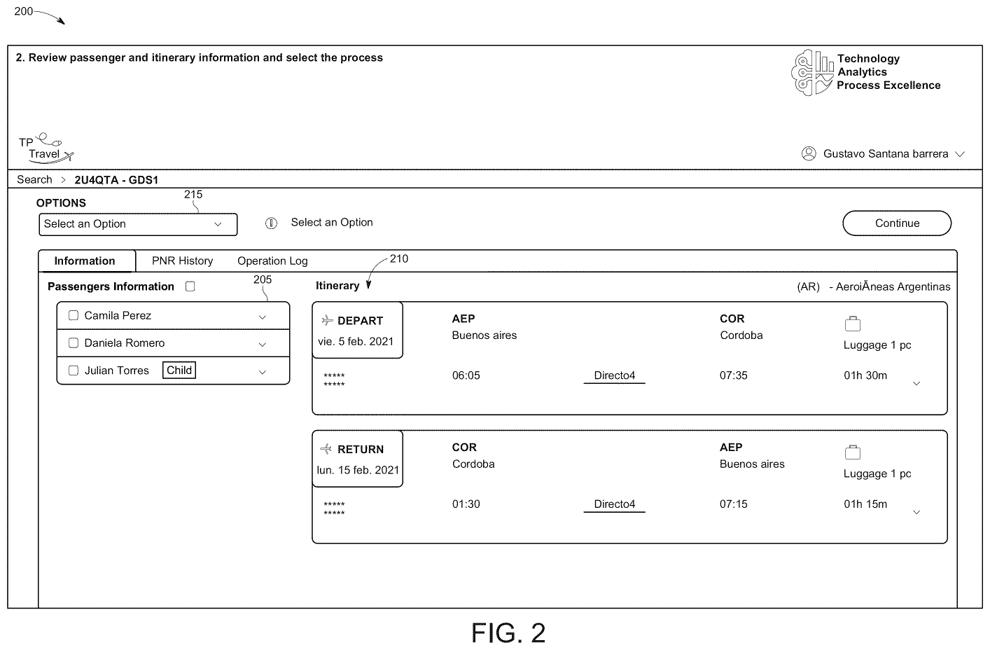

With regard to FIG. 1, an exemplary on-screen graphical user interface (GUI) 100 for identifying and accessing information pertaining to an existing airline reservation is depicted according to embodiments of the present invention. In the example of FIG. 1, the airline reservation is identified by the user (e.g., an agent) entering a reservation number (e.g., a confirmation or ticket number) that is associated with an existing reservation using reservation number field 105. PNR/TKT field 110 is used to identify the reservation number as a passenger name reservation number (PNR) or an electronic ticket number (TKT) for accessing the reservation from the associated GDS. GDS field 115 identifies the name of the GDS used to host information for the relevant airline, such as Amadeus, CRS, SABRE, etc. In this example, Amadeus is the selected GDS. Activating on-screen search button 120 of the GUI causes the relevant information to be retrieved from the Amadeus GDS for modifying the flight as depicted in FIG. 2 below.

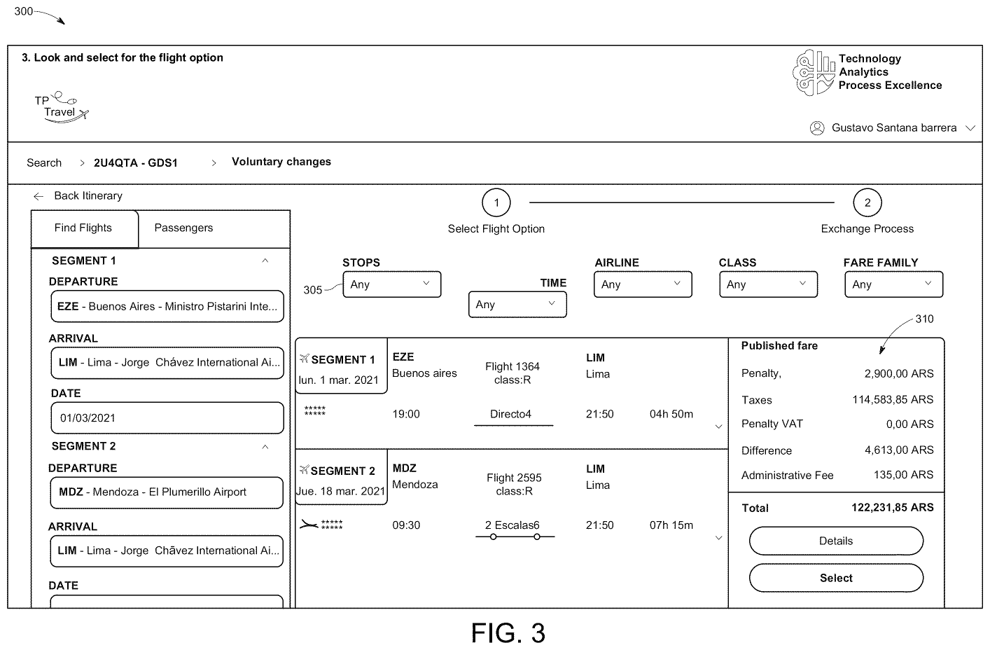

FIG. 2 depicts an exemplary on-screen graphical user interface 200 for reviewing passenger and itinerary information associated with an existing airline reservation according to embodiments of the present invention. The passenger information 205 and itinerary information 210 are associated with the reservation number entered in reservation number field 105 depicted in FIG. 1, for example. Itinerary information 210 includes the departure date and any return date, as well as the flight time, airline, airport, and other information, such as the number of checked bags. A specific passenger or passengers can be selected to make voluntary changes to the reservation, as depicted in FIG. 3. In the example of FIG. 2, itinerary information 210 includes a Feb. 5, 2021 flight from Buenos Aires to Cordoba, and a Feb. 15, 2021 return flight from Cordoba to Buenos Aires. To modify the existing reservation, the modification option is selected from options menu 215.

FIG. 3 depicts an exemplary on-screen graphical user interface 300 for modifying itinerary information of an existing airline reservation according to embodiments of the present invention. As depicted in FIG. 3, segment 1 and segment 2 of the existing reservation can be modified by selecting a new flight for the respective segments of the existing reservation. In this example, segment 1 of the modified itinerary includes a Mar. 1, 2021 flight from Buenos Aires to Lima, and segment 2 of the modified itinerary includes a Mar. 18, 2021 flight from Mendoza to Lima. The available flights can be filtered using flight option filter 305 based on the number of stops, the time of the flight, the ticket class, and family fare availability. The published fare including any penalty, applied taxes, and administrative fees is depicted in fare information 310.

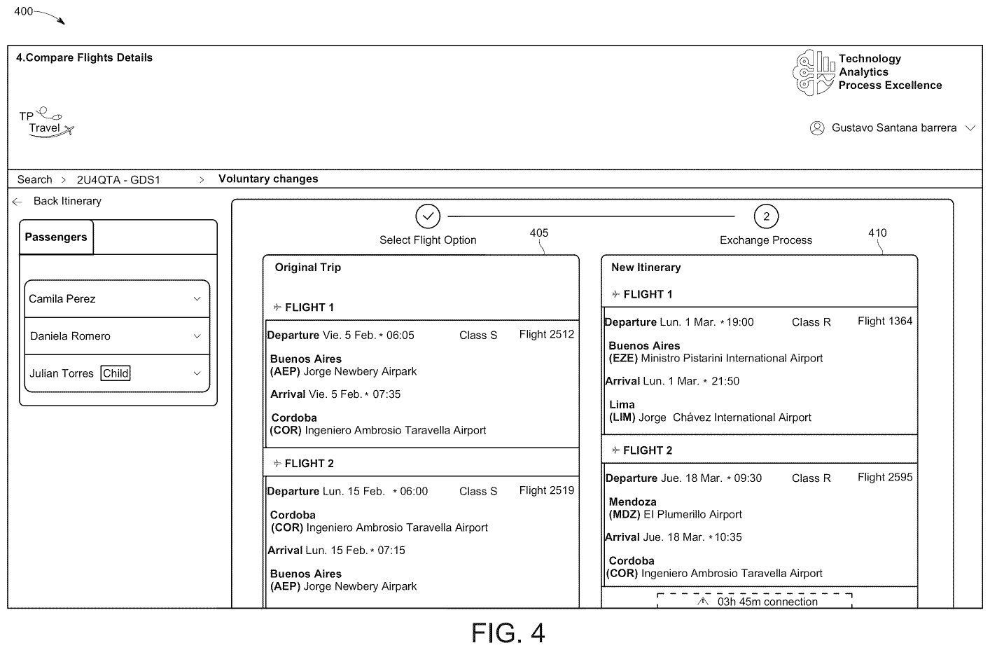

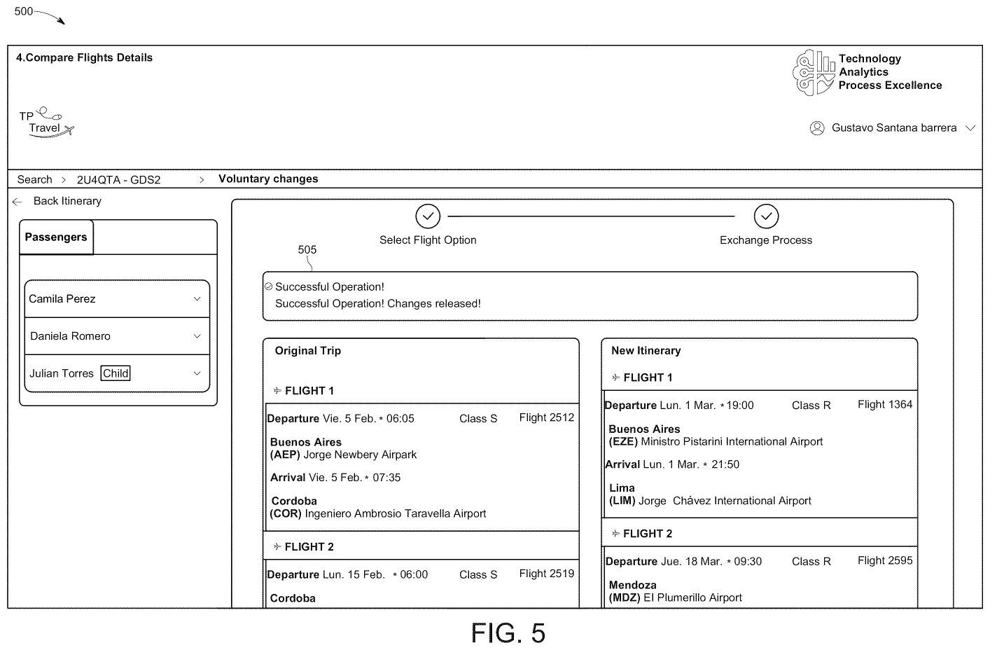

FIG. 4 depicts an exemplary on-screen graphical user interface 400 including information of both the existing itinerary 405 and the new itinerary 410 for comparing details of the respective flights during a reservation modification process according to embodiments of the present invention. Graphical user interface 400 can be used by an agent to conveniently review voluntary changes and for comparing the existing reservation 405 to the new itinerary 410. The details of multiple flights can be displayed on and the details of the flight include the departure date and time, the class of ticket, the flight number, the departure city and airport, and the arrival city and airport. The graphical user interface 400 can also display other information, such as information regarding connecting flights. As depicted in FIG. 5, exemplary on-screen graphical user interface 500 displays a confirmation 505 indicating that the original itinerary has been modified successfully according to embodiments of the present invention. At this time, the changes are released (e.g., input, transmitted, delivered) to the selected GDS. Similarly, a failure to release changes to the selected GDS can be indicated on graphical user interface 500.

### User Interface for Airline Reservation Cancellation

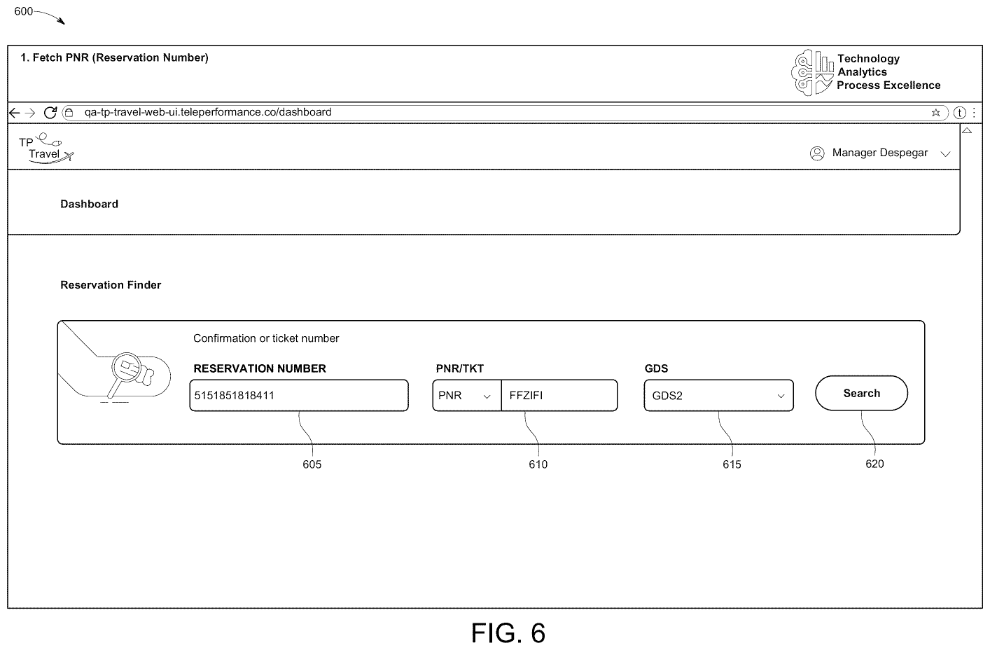

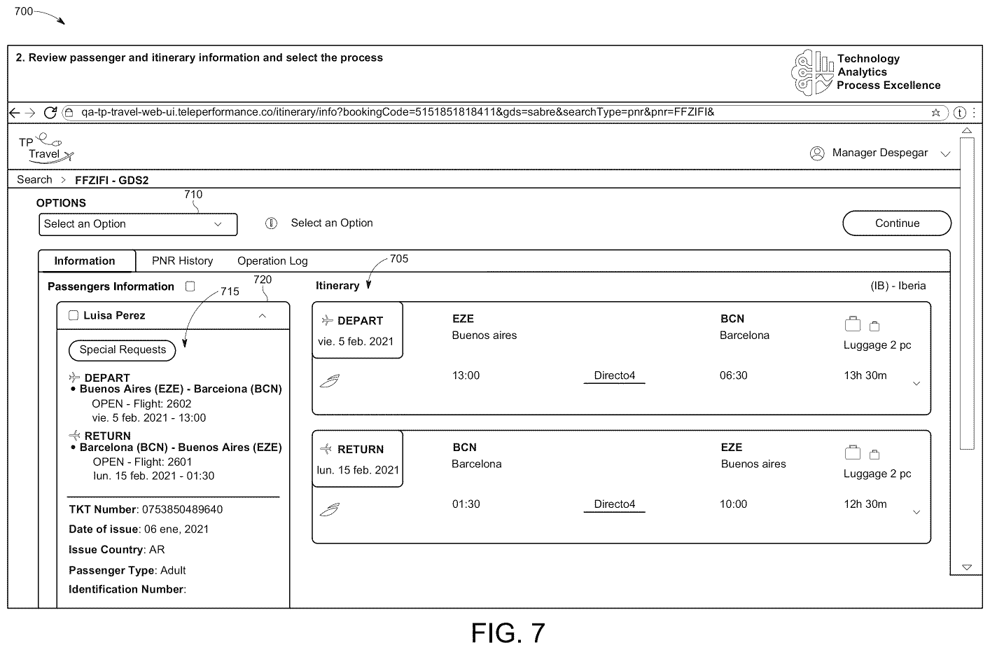

With regard to FIG. 6, an exemplary on-screen graphical user interface 600 for canceling an existing airline reservation is depicted according to embodiments of the present invention. In the example of FIG. 6, the airline reservation is identified by entering a reservation number (e.g., a confirmation or ticket number) that is associated with an existing reservation using reservation number field 605. PNR/TKT Field 610 is used to identify the reservation number as a PNR or an TKT for accessing the reservation from the associated GDS. GDS field 615 identifies the GDS system used to host the requested information, such as Amadeus, CRS, Sabre, etc. In this example, Sabre is the selected GDS. Activating search button 620 causes the relevant information to be retrieved from the associated GDS system for canceling the flight as depicted in FIG. 7 below.

FIG. 7 depicts an exemplary on-screen graphical user interface 700 for reviewing passenger itinerary and canceling an existing airline reservation according to embodiments of the present invention. The itinerary information 705 displays a departure on Feb. 5, 2021 and a return flight on Feb. 15, 2021 for passenger Luisa Perez. By selecting cancellation from options menu 710, the flights displayed in itinerary information 705 can be selected for cancellation. As depicted in FIG. 7, passenger information 715 can be displayed for a specific passenger by expanding the window using expand button 720.

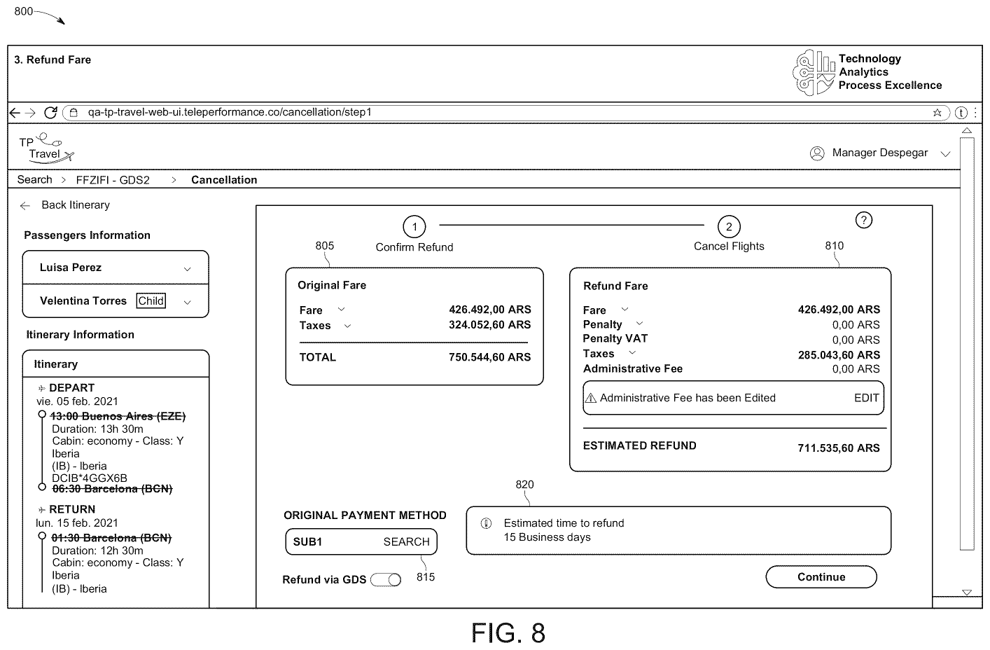

As depicted in FIG. 8, exemplary on-screen graphical user interface 800 displays confirmation information for a flight cancelation according to embodiments of the present invention. The original fare information 805 displays the fare, taxes, and total cost of the existing reservation. Refund fare information 810 shows the amount of any refund, for example, the original fare and any taxes paid, minus any penalties and fees. The original payment method 815 and the estimated time to refund 820 are also displayed on graphical user interface 800. Activating confirmation button 825 confirms cancelation of the displayed flights. According to some embodiments, activating confirmation button 825 releases the flight cancelation to the associated GDS.

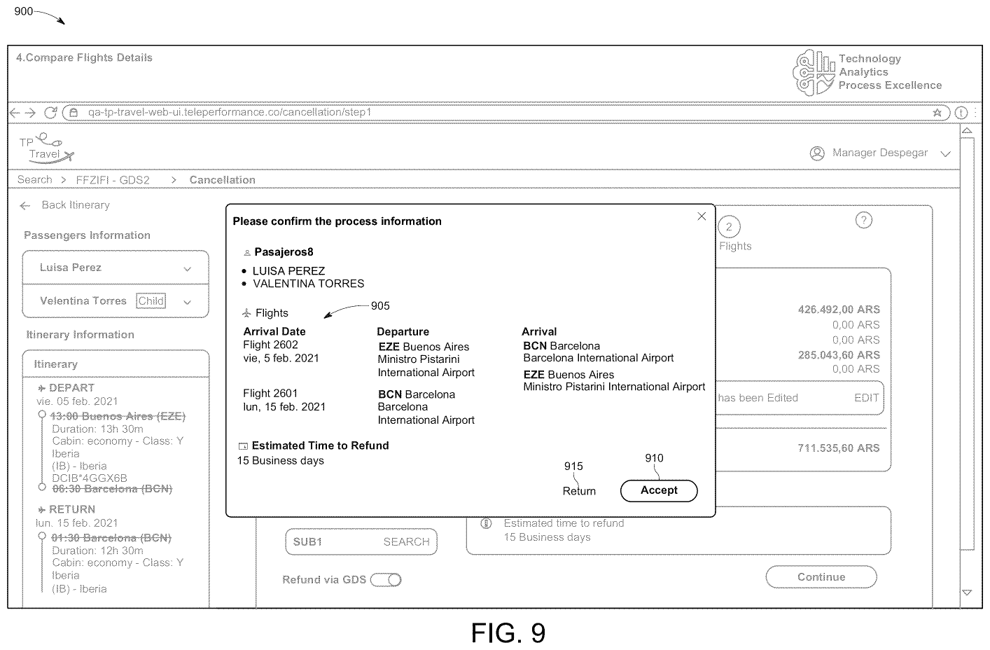

As depicted in FIG. 9, according to some embodiments, a confirmation dialogue is displayed on exemplary on-screen user interface 900 that includes the relevant flight information 905 and an accept button 910 for finalizing the cancellation of the displayed flights and releasing the flight cancelation to the associated GDS. Alternatively, return button 915 can be activated to return to a prior screen, such as graphical user interface 800 displayed in FIG. 8.

### Exemplary Methods for Flight Reservation Modification and Cancelation

FIG. 10 is a flow chart depicting an exemplary computer-implemented process 1000 for modifying an existing airline reservation hosted on a GDS using an interactive graphical user interface according to embodiments of the present invention. For example, interactive elements (e.g., buttons, menus, and fields) of a graphical user interface can be configured to automatically send instructions and commands to a GDS for modifying existing airline reservations using existing APIs, and to automatically present and collect any associated fares, fees, and taxes accordingly. Furthermore, the user interface can be configured to display costs and fees in a desired currency during process 1000, and the costs and fees can automatically be converted to the desired currency and displayed on the graphical user interface.

At step 1005, a flight reservation number associated with an existing reservation is received at a field of the graphical user interface. The flight reservation number can be a PNR or TKT number, for example.

At step 1010, the flight reservation number is transmitted, delivered, or otherwise input into the remote GDS for retrieving flight information associated with the existing reservation according to the flight reservation number. Step 1005 can also include receiving an identification of the GDS that hosts the flight information and an identification of the type of flight reservation number entered, such as PNR or TKT.

At step 1015, the flight information stored on the GDS associated with the existing reservation is accessed and can be displayed on the graphical user interface.

At step 1020, reservation modification information is received at the graphical user interface for modifying the flight information. The reservation modification information can include a selection of a new flight or flights, modified arrangements such as ticket class, accommodations, etc., and these modifications can be entered using interactive elements of the graphical user interface.

At step 1025, the reservation modification information is mapped to one or more commands of an API used to communicate with the GDS.

At step 1030, the GDS commands mapped to the reservation modification information are released (e.g., transmitted, delivered, input, etc.) to the GDS to modify the existing reservation. The commands can include arguments/data representing the modified itinerary using API configured to communicate with the GDS. Step 1025 can include displaying an additional confirmation screen that compares the existing reservation to a modified itinerary that reflects the reservation modification information, and can further include displaying a confirmation dialogue for confirming the modifications.

FIG. 11 is a flow chart depicting an exemplary computer-implemented process 1100 for canceling an existing airline reservation hosted on a GDS using an interactive graphical user interface according to embodiments of the present invention. For example, interactive elements (e.g., buttons, menus, and fields) of a graphical user interface can be configured to automatically send instructions and commands to a GDS for modifying existing airline reservations using existing APIs, and to automatically present and collect any associated fares, fees, and taxes accordingly. The modification of the existing reservation is performed by the GDS according to pre-defined rules associated with the relevant airline. Furthermore, the user interface can be configured to display costs and fees in a desired currency during process 1100, and the costs and fees can automatically be converted to the desired currency and displayed on the graphical user interface.

At step 1105, a flight reservation number associated with an existing reservation is received at a field of the graphical user interface. The flight reservation number can be a PNR or TKT number, for example. Step 1105 can also include receiving an identification of the GDS that hosts the flight information and an identification of the type of flight reservation number entered, such as PNR or TKT.

At step 1110, the flight reservation number is transmitted, delivered, or otherwise input into the remote GDS for retrieving flight information associated with the existing reservation according to the flight reservation number.

At step 1115, the flight information stored on the GDS associated with the existing reservation is accessed and can be displayed on the graphical user interface.

At step 1120, a reservation cancelation request is received at the graphical user interface for canceling the existing reservation associated with the flight reservation number received in step 1105.

At step 1125, the cancelation request is mapped to one or more commands of an API used to communicate with the GDS.

At step 1130, GDS commands mapped to the reservation modification information are released (e.g., transmitted, delivered, input, etc.) to the GDS to cancel the existing reservation. The commands can include arguments/data representing the modified itinerary using API configured to communicate with the GDS. Step 1130 can include displaying an additional confirmation screen that shows the amount of fare, taxes, and fees that will be refunded by canceling the existing reservation, and can further include displaying a confirmation dialogue for confirming the cancelation. The cancelation is performed by the GDS according to pre-defined rules associated with the relevant airline.

### Exemplary Computer Controlled System

Embodiments of the present invention are drawn to methods and graphical user interfaces that cause a computer system to send instructions to modify or cancel existing airline reservations hosted on a GDS. The following discussion describes one such exemplary electronic system or computer system can be used as a platform for implementing embodiments of the present invention.

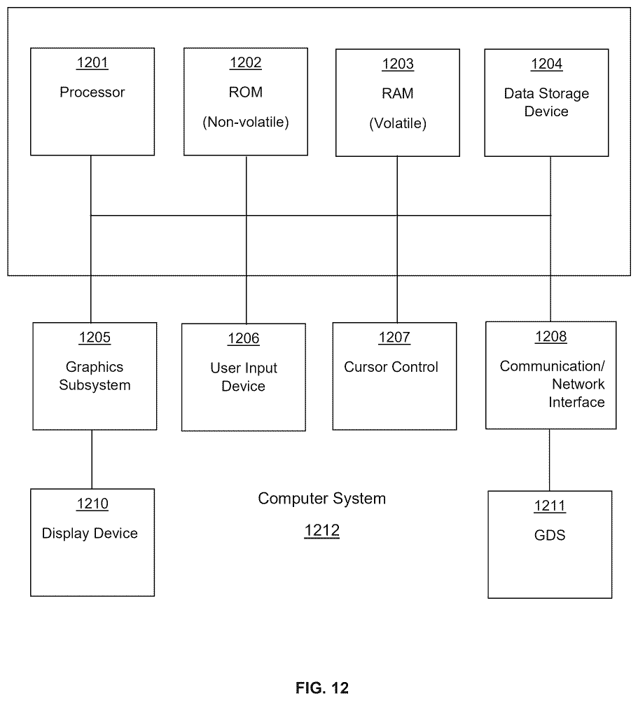

In the example of FIG. 12, the exemplary computer system 1212 includes a central processing unit (such as a processor or a CPU) 1201 for running software applications and optionally an operating system. Random access memory 1202 and read-only memory 1203 store applications and data for use by the CPU 1201. Data storage device 1204 provides non-volatile storage for applications and data and may include fixed disk drives, removable disk drives, flash memory devices, and CD-ROM, DVD-ROM or other optical storage devices. The optional user inputs 1206 and 1207 comprise devices that communicate inputs from one or more users to the computer system 1212 (e.g., mice, joysticks, cameras, touch screens, and/or microphones) and can be used to interact with an on-screen graphical user interface. The exemplary computer system 1212 can be a personal computer, laptop, mobile device (e.g., smartphone), or any similar device capable of receiving user input and sending and receiving data with a remote computer system.

A communication or network interface 1208 allows the computer system 1212 to communicate with other computer systems, networks, or devices via an electronic communications network, including wired and/or wireless communication and including an Intranet or the Internet. For example, the computer system 1212 can communicate remotely with GDS 1211 to access existing reservations and submit modifications and cancelations to GDS 1211 for modifying or canceling an existing reservation stored on or hosted by GDS 1211. The display device 1210 may be any device capable of displaying visual information in response to a signal from the computer system 1212 (e.g., an interactive graphical user interface) and may include a flat panel touch sensitive display, for example, and may be remotely disposed. The components of the computer system 1212, including the CPU 1201, memory 1202/1203, data storage 1204, user input devices 1206, and graphics subsystem 1205 may be coupled via one or more data buses.

Embodiments of the present invention are thus described. While the present invention has been described in particular embodiments, it should be appreciated that the present invention should not be construed as limited by such embodiments, but rather construed according to the following claims.

What is claimed is:

1. A computer implemented apparatus for rendering a graphical user interface (GUI) operable to display real-time flight data accessed from a remote global distribution system (GDS), the apparatus comprising:
a processor;
a memory coupled to the processor; and
a display device operable to receive instructions from the processor and render the GUI according to the instructions, wherein the GUI comprises:
a first graphical display region configured to be rendered on the display device and comprising display elements representing an original trip itinerary, wherein the original trip itinerary comprises first flight data accessed from the GDS; and
a second graphical display region configured to be rendered on the display device and comprising display elements representing a modified trip itinerary, wherein the modified trip itinerary comprises second flight data, wherein the second flight data is different than the first flight data, wherein the first graphical display region and the second graphical display region are displayed simultaneously in the GUI, and wherein the second flight data is rendered responsive to a flight selection by a user interacting with the GUI.

2. The apparatus of claim 1, wherein the GUI further comprises an on-screen displayed flight reservation number field operable to receive a flight reservation number as user input.

3. The apparatus of claim 2, wherein the original trip itinerary is accessed according to the flight reservation number input at the flight reservation number field.

4. The apparatus of claim 2, wherein the flight reservation number corresponds to a particular airline ticket.

5. The apparatus of claim 1, wherein the GUI further comprises an on-screen displayed GDS identification field operable to receive input indicating a specific GDS that stores the first flight data.

6. The apparatus of claim 1, wherein the GUI further comprises a display region operable to render on-screen costs associated with the modified trip itinerary, wherein the GDS is operable to automatically present and collect any associated fares, fees, and taxes according to pre-defined rules of an airline associated with the second flight data responsive to legacy API commands.

7. The apparatus of claim 1, wherein the processor is operable to convert costs associated with the modified trip itinerary from a first currency to a second currency, and wherein the GUI further comprises an on-screen a display region operable to render a representation of the costs associated with the modified trip itinerary in the second currency.

8. The apparatus of claim 1, wherein the modified trip itinerary is rendered in the GUI in a format according to pre-defined rules of an airline associated with the second flight data.

9. The apparatus of claim 8, wherein the GUI further comprises an on-screen displayed confirmation graphical display button that releases the modified trip itinerary to the GDS to modify the original trip itinerary using the second flight data, wherein the GDS modifies the original trip itinerary according to the pre-defined rules of the airline associated with the second flight data, and wherein the pre-defined rules comprise at least one of: allowed travel dates; allowed travel times; flight prices; and booking fees.

10. The apparatus of claim 9, wherein a first ticket associated with the first flight data of the original trip itinerary is automatically replaced by a second ticket associated with the second flight data of the modified itinerary responsive to a user interaction with the confirmation button of the GUI when the modified itinerary complies with the pre-defined rules.

11. A method of on-screen rendering of a graphical user interface (GUI) operable to display real-time flight data accessed from a remote global distribution system (GDS) server, the method comprising:
accessing first flight data from the GDS;
rendering the GUI on a display screen, the GUI comprising a first graphical display region comprising an original trip itinerary, wherein the original trip itinerary comprises the first flight data accessed from the GDS;
receiving a user selection of a display element of the GUI, the selection comprising second flight data;
rendering a second graphical display region within the GUI, the second display region comprising a modified trip itinerary, wherein the modified trip itinerary comprises the second flight data, wherein the second flight data is different than the first flight data, and wherein the first graphical display region and the second graphical display region are displayed simultaneously in the GUI; and
receiving a user confirmation input via a confirmation graphical display button rendered in the GUI that is configured to release the modified trip itinerary to the GDS to modify the original trip itinerary using the second flight data.

12. The method of claim 11, wherein the GUI further comprises an on-screen displayed flight reservation number field operable to receive a flight reservation number as input.

13. The method of claim 12, wherein the original trip itinerary is accessed according to the flight reservation number input at the flight reservation number field.

14. The method of claim 12, wherein the flight reservation number corresponds to a particular airline ticket.

15. The method of claim 11, wherein the GUI further comprises an on-screen displayed GDS identification field operable to receive input indicating a specific GDS that stores the first flight data.

16. The method of claim 11, wherein the GUI further comprises a display region operable to render costs associated with the modified trip itinerary, wherein the GDS is operable to automatically present and collect any associated fares, fees, and taxes according to pre-defined rules of an airline associated with the second flight data responsive to legacy API commands.

17. The method of claim 11, further comprising converting costs associated with the modified trip itinerary from a first currency to a second currency, and wherein the GUI further comprises another display region operable to render a representation of the costs associated with the modified trip itinerary in the second currency.

18. The method of claim 11, further comprising generating the modified trip itinerary according to pre-defined rules of an airline associated with the second flight data.

19. The method of claim 18, wherein a first ticket associated with the first flight data of the original itinerary is replaced by a second ticket associated with the second flight data of the modified itinerary responsive to a user interaction with the confirmation button of the GUI, wherein the GDS modifies the original trip itinerary according to the pre-defined rules of the airline associated with the second flight data, wherein the pre-defined rules comprise at least one of: allowed travel dates; allowed travel times; flight prices; and booking fees.

20. A non-transitory computer-readable storage medium having embedded therein program instructions, which when executed by one or more processors of a device, cause the device to perform a method of rendering a graphical user interface (GUI) on a display screen, the GUI operable to display real-time flight data accessed from a remote global distribution system (GDS) server, the method comprising:
accessing first flight data from the GDS;
rendering the GUI on the display screen, the GUI comprising a first graphical display region comprising an original trip itinerary, wherein the original trip itinerary comprises the first flight data accessed from the GDS;
receiving a user selection of a display element of the GUI, the selection comprising second flight data;
rendering a second graphical display region within the GUI, the second display region comprising a modified trip itinerary, wherein the modified trip itinerary comprises the second flight data, wherein the second flight data is different than the first flight data, and wherein the first graphical display region and the second graphical display region are displayed simultaneously in the GUI; and
receiving a user confirmation input via a confirmation button rendered in the GUI that releases the modified trip itinerary to the GDS to modify the original trip itinerary using the second flight data.

21. The non-transitory computer-readable storage medium of claim 20, wherein the GUI further comprises an on-screen displayed flight reservation number field operable to receive a flight reservation number as input.

22. The non-transitory computer-readable storage medium of claim 20, wherein the original trip itinerary is accessed according to the flight reservation number input at the flight reservation number field.

23. The non-transitory computer-readable storage medium of claim 20, wherein the flight reservation number corresponds to a particular airline ticket.

24. The non-transitory computer-readable storage medium of claim 20, wherein the GUI further comprises an on-screen displayed GDS identification field operable to receive input indicating a specific GDS that stores the first flight data.
